(19) United States
(12) Patent Application Publication
(10) Pub. No.: US 2009/0323610 A1
(43) Pub. Date: Dec. 31, 2009

(54) BONDING ADJACENT TV BANDS, SUB-CARRIER ALLOCATION, DATA BURST DEFINITION AND SPREAD OFDMA IN A PHYSICAL LAYER FOR 802.22 WRAN COMMUNICATION SYSTEMS

(75) Inventors: Vasanth R. Gaddam, Tarrytown, NY (US); Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/441,610

(22) PCT Filed: Sep. 21, 2007
(86) PCT No.: PCT/IB07/53843

§ 371 Date: Mar. 17, 2009

Related U.S. Application Data
(60) Provisional application No. 60/826,972, filed on Sep. 26, 2006.

(51) Int. Cl. H04N 7/24; H04W 4/00

(52) U.S. Cl. 370/329; 375/E07.017

(57) ABSTRACT

A method and system of calculating debt service capacity of a loan applicant includes capturing, indexing, reclassifying and grouping transaction data and profile data of the loan applicant. Next, capturing a loan structure, risk factors, financial variables and reconciliation rules and finally using the aforementioned and loan applicants' data and cash flow projections to calculate loan applicants' debt service capacity with time value of money calculations.

### RELATED APPLICATIONS

The present invention is related to the following copending applications whose entire contents are hereby incorporated herein by reference as if fully set forth herein:

Provisional application entitled “Cognitive MAC (CMAC) Proposal for IEEE 802.22 WRAN Systems”, Carlos CORDEIRO et al, attorney docket number 2904, filed Sep. 16, 2005;

“Spectrum Management in Dynamic Spectrum Access Wireless Systems”, Carlos Cordeiro et al., attorney docket number 2296, filed Nov. 4, 2005 and

“Physical Layer Superframe, Frame, Preamble and Control Header for IEEE 802.22 WRAN Communication Systems,” by Vasanth GADDAM et al, attorney docket number 6330.

This invention relates to a physical layer (PHY) for IEEE 802.22 WRAN systems. More particularly this invention provides for bonding adjacent TV bands for a PHY layer of WRAN systems. Most particularly, this invention provides some key elements of the PHY such as channel bonding, sub-carrier allocation, data burst definition and spread OFDMA modulation for WRAN communication systems.

The IEEE 802.22 working group is chartered to develop a standard for a cognitive radio-based PHY/MAC/air_interface for use by license-exempt devices on a non-interfering basis in spectrum that is allocated to the TV Broadcast Service. In this regard, the working group has issued a call for proposals (CFP) requesting submissions of proposals towards the selection of technologies for the initial 802.22 Specification. One of the applications where the standard can be used is in wireless regional area networks (WRANs). Such service is directed to bringing broadband access to rural and remote areas by taking advantage of unused TV channels extant in these sparsely populated areas.

The primary consideration is that license-exempt devices, also known as consumer premise equipment (CPE), avoid interference with incumbent TV broadcasting, wireless microphones and public safety systems. Accordingly, efficient and effective use of unused TV bandwidth is a primary objective of a PHY air interface for a WRAN.

Operation of WRAN systems is based on fixed wireless access being provided by bases stations (BSs) operating under a universally accepted standard that controls the Radio Frequency (RF) characteristics of the CPEs (user terminals). The CPEs are expected to be readily available from consumer electronic stores, no need to be licensed or registered, include interference sensing and be installed by a user or by a professional. A CPE is expected to be RF device based on low-cost UHF-TV tuners. The RF characteristics of the CPE are under total control of the BS but RF signal sensing is expected to be accomplished by the base station and the CPEs under control of the BS. The latter centralized control allows a BS to aggregate the TV sensing information centrally and take action at the system level to avoid interference, e.g., change frequency and make more efficient use of unused TV spectrum, e.g., bond contiguous unused TV channels.

Thus, a wireless PHY air interface, that makes efficient use of available bandwidth, is needed.

The present invention provides a system, apparatus and method for a PHY layer of an IEEE 802.22 communication system that includes:
1. Channel Bonding of empty adjacent TV channels;
2. Sub-Carrier Allocation—
   a. sub-channel definition for different channel bonding options, and
   b. pilot and data carrier allocation within a sub-channel;
3. Data Burst Definition; and
4. Spread OFDMA Modulation.

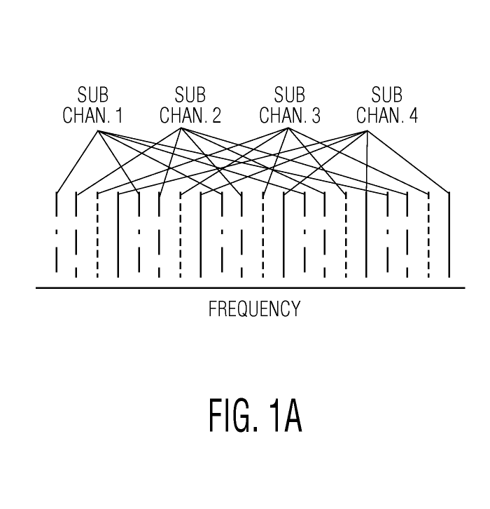

FIG. 1A illustrates a preferred embodiment of a sub-carrier allocation scheme, according to the present invention;

FIG. 1B illustrates a sub-channel numbering scheme for different number of bonded TV channels;

FIG. 1C illustrates an example of various types of contemporaneous channel usage, including channel bonding;

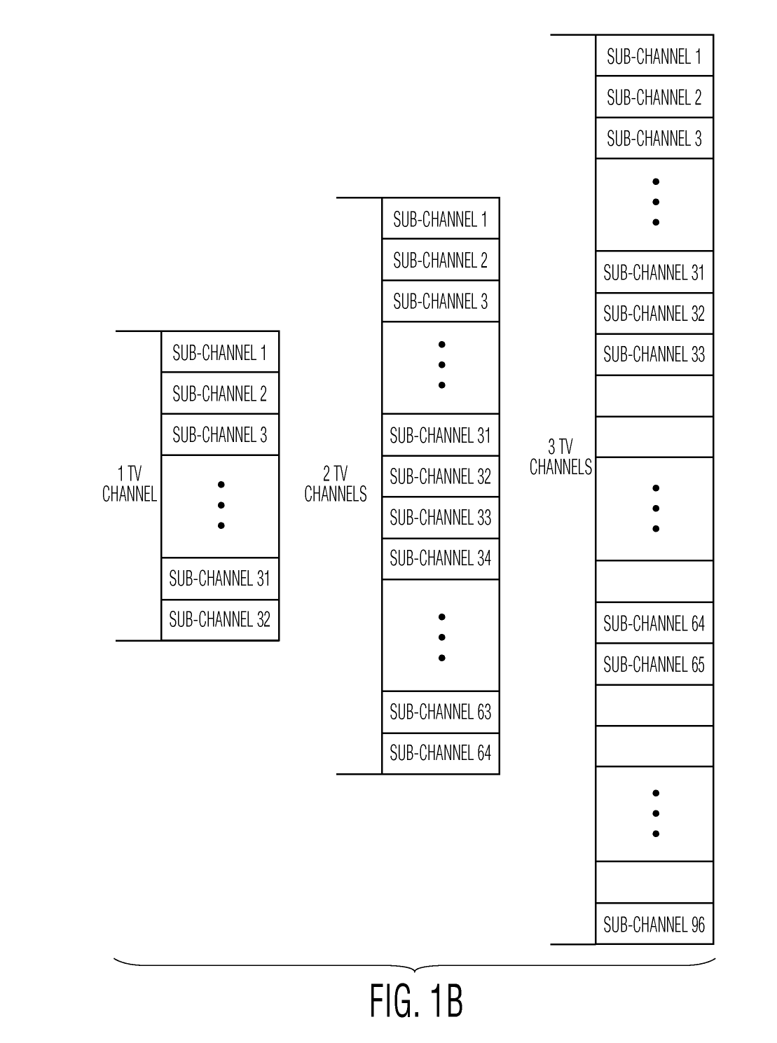

FIG. 2 illustrates an OFDMA symbol format, according to the present invention;

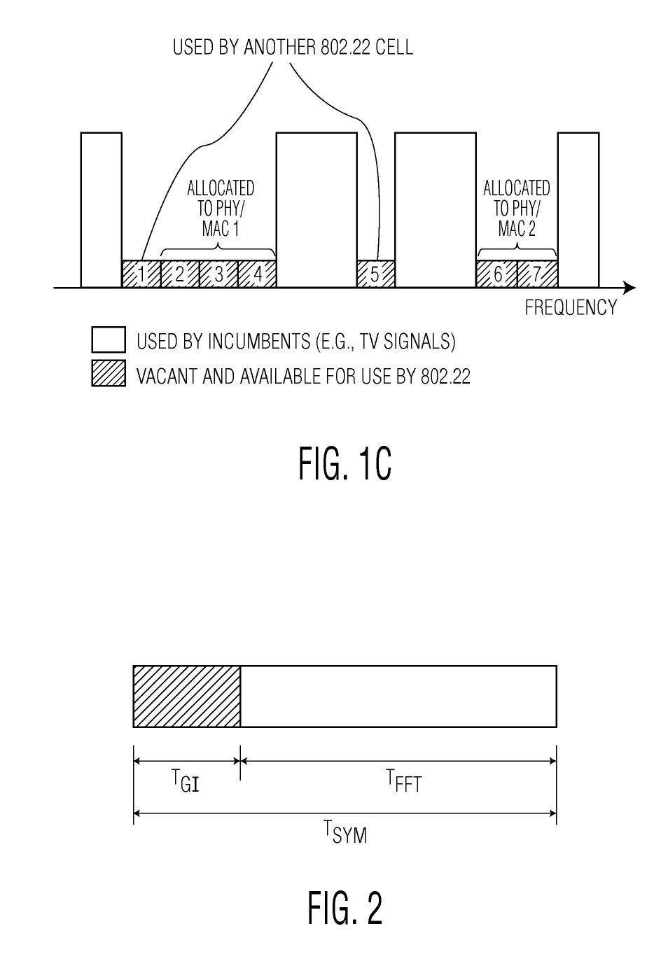

FIG. 3 illustrates a frequency domain description of OFDMA signal (assuming a 6 MHz TV channel);

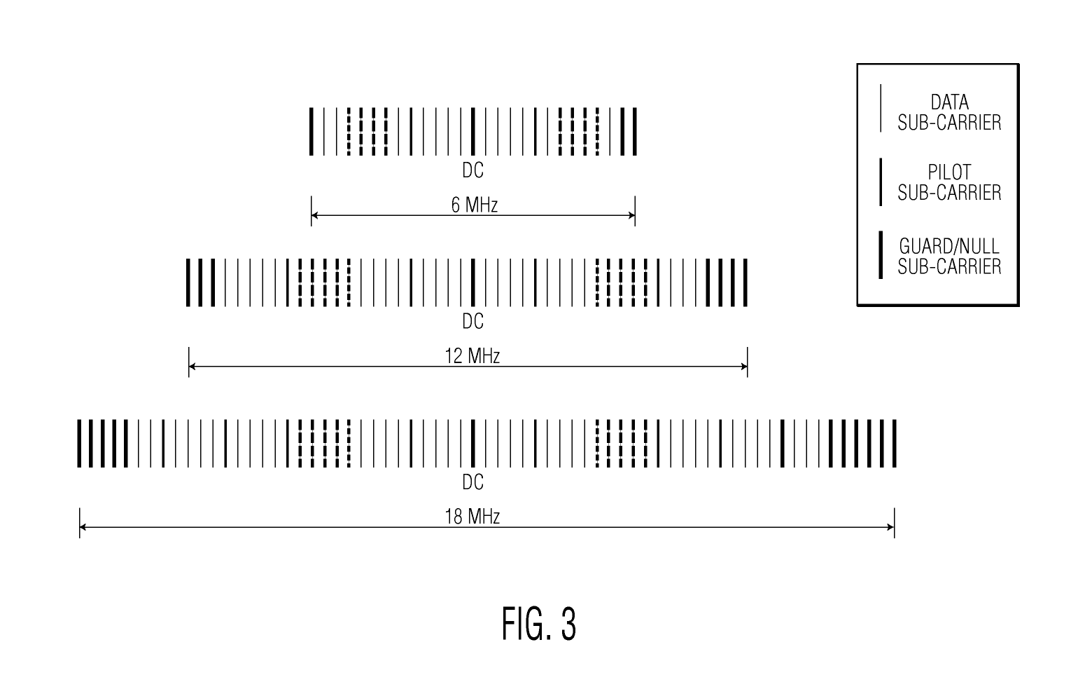

FIG. 4 illustrates a channel coding process;

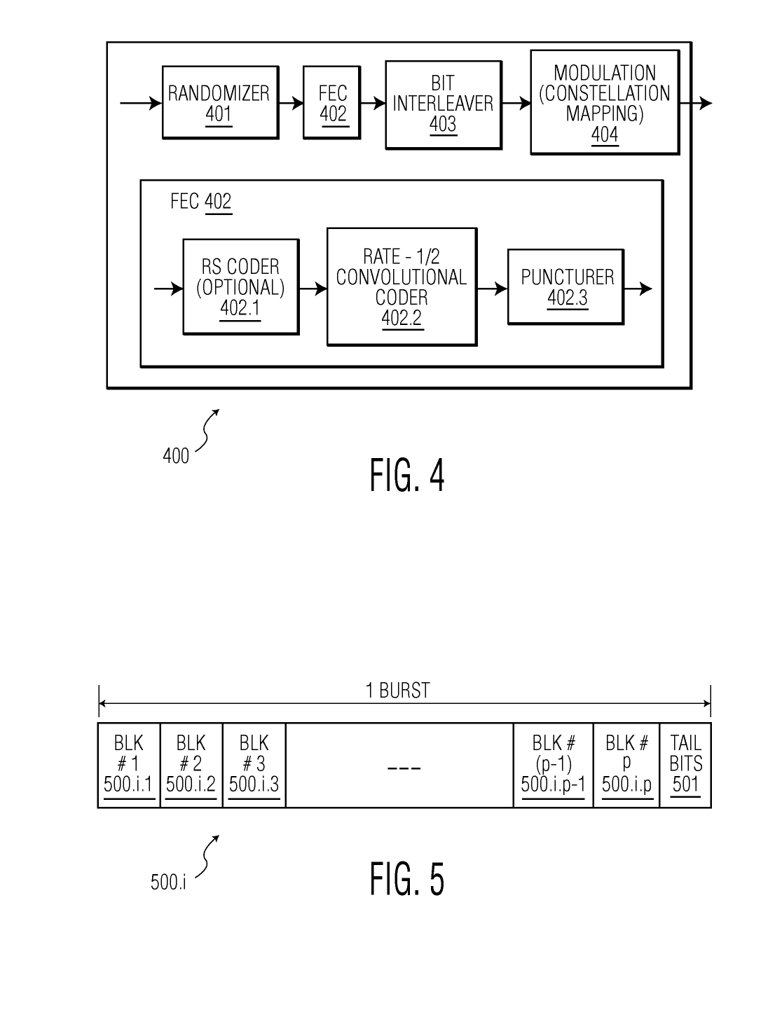

FIG. 5 illustrates partitioning of a data burst into data blocks;

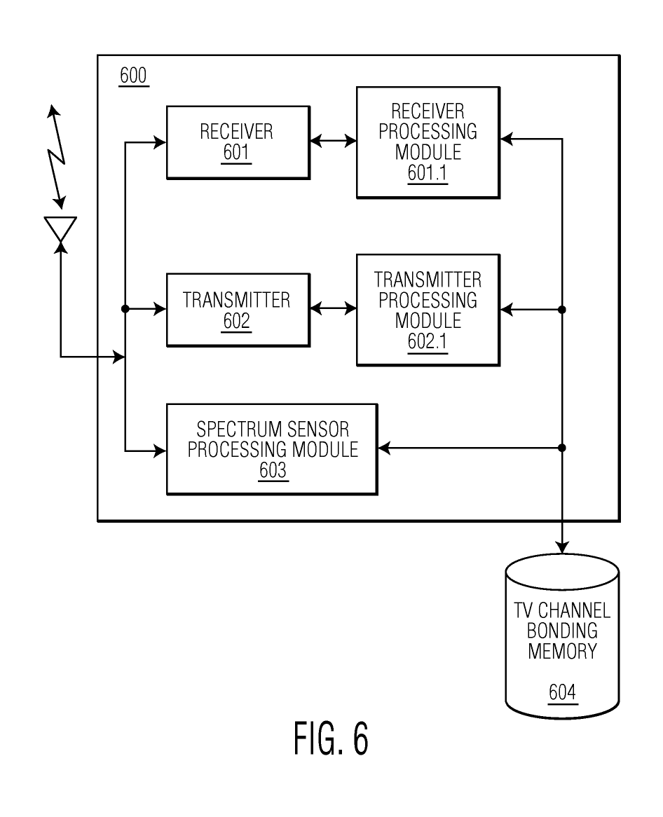

FIG. 6 illustrates a block diagram of a CPE modified according to the present invention;

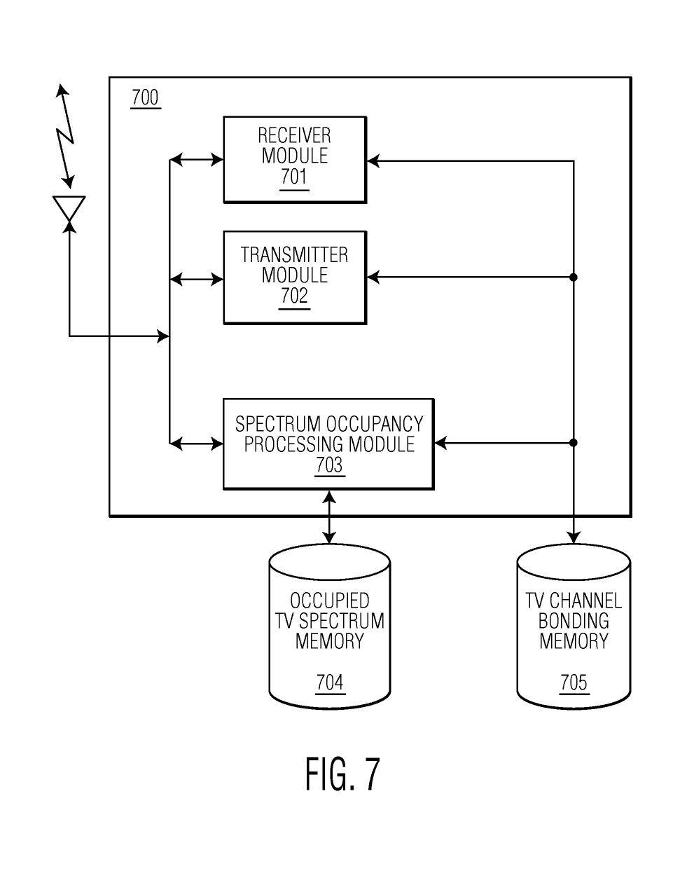

FIG. 7 illustrates a block diagram of a BS modified according to the present invention;

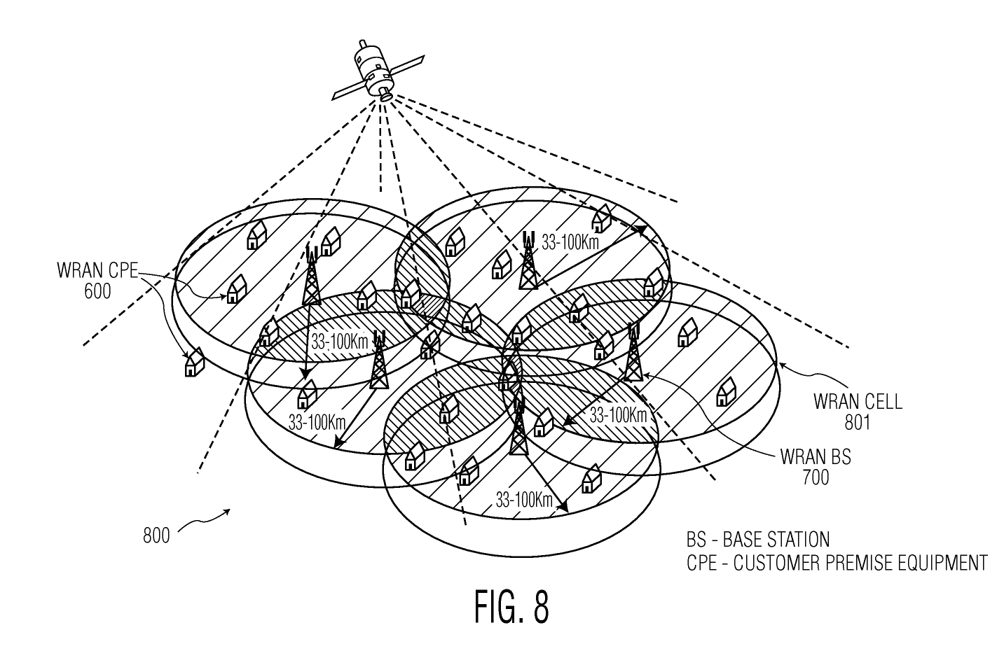

FIG. 8 illustrates a WRAN system of a BS and CPEs according to the present invention;

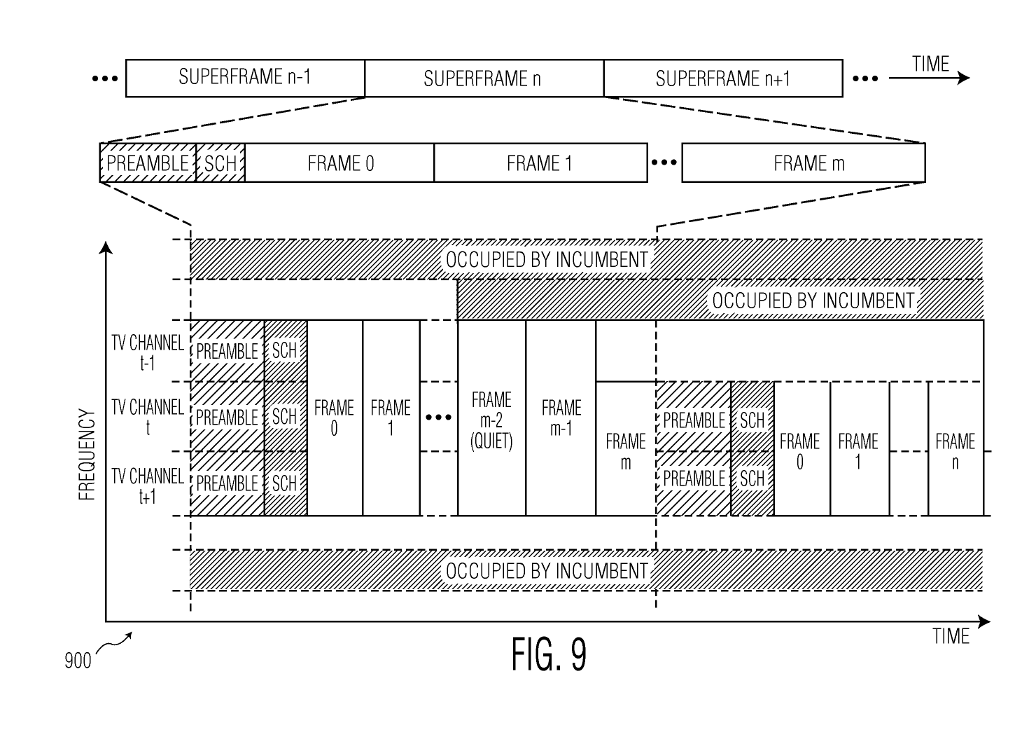

FIG. 9 illustrates a superframe structure; and

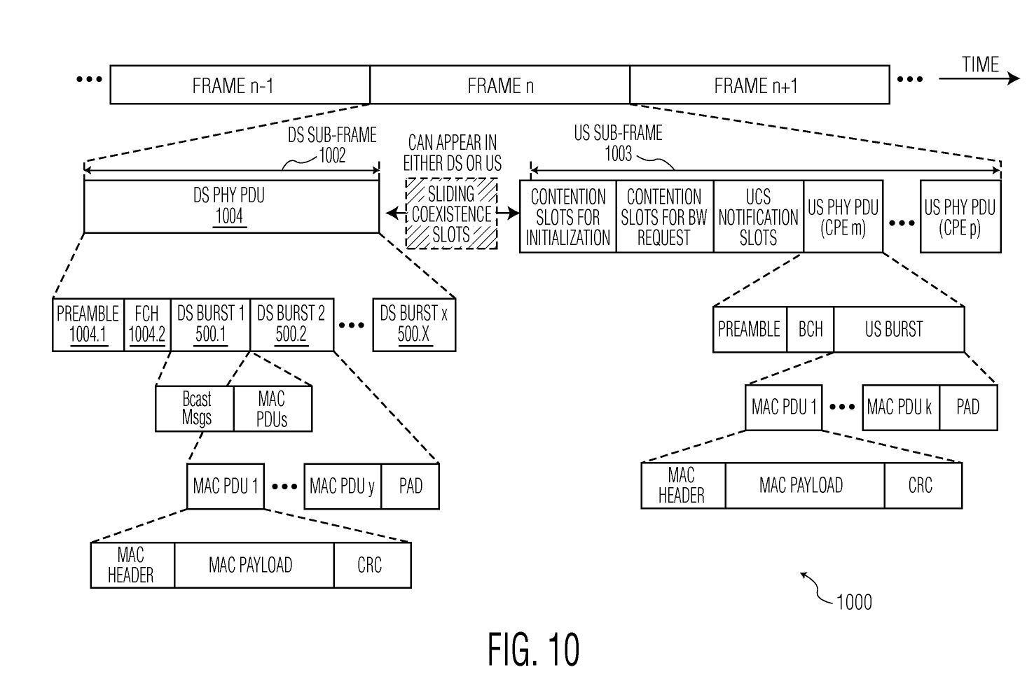

FIG. 10 illustrates a frame structure.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and structure may be omitted from the current descriptions so as not to obscure the present invention.

A WRAN system must be able to maximize the utilization of vacant TV bands. One approach towards this end is to bond the adjacent TV bands that are not occupied by incumbents, i.e., that are empty. The present invention provides a system, apparatus and method to bond up to three vacant and adjacent TV channels in an implementation-friendly manner. The present invention also applies when more than three bands are available for bonding.

One set of contiguous channels among a spectrum of non-contiguous channels can be assigned to each MAC/PHY stack in the present invention. These contiguous channels are ‘bonded’ together for use by the CPEs 600 of the system 800. The superframe structure 900 is useful in providing access by CPEs 600 to multiple restricted TV channels bonded together by a BS 700. Illustratively, wireless networks 800 are adapted to operate in the VHF and/or UHF TV bands using a MAC/PHY stack assignment and superframes. In the United States (and some other countries) where the TV channelization is 6 MHz, the superframe 900 could be employed to efficiently bond 6 MHz (one channel), 12 MHz (two channels), and 18 MHz (three channels) and so on. Thus, a parallel communication of the superframe preamble and the SCH fosters efficient use of the bonded channels by CPEs 600 entering the network 800 (e.g., WRAN cell 801).

When multiple TV bands are available (i.e. under flexible bandwidth scenarios), two approaches are currently available in OFDM/OFDMA systems to make full use of the available bandwidth. In a first approach, an FFT period (and a symbol period) is kept constant for different bandwidth options. In this first approach, the FFT size is varied to change with the available bandwidth. In a second approach, the FFT size is fixed for different bandwidth options and the FFT period (and the symbol period) is varied to change with the available bandwidth.

A preferred embodiment of the present invention employs the first approach. Keeping the FFT period constant with varying bandwidth provides implementation advantages such as fixed sampling rate, simple filtering schemes, etc. Fixed FFT period translates to fixed inter-carrier spacing. In an OFDM/OFDMA system, inter-carrier spacing is determined based on the symbol rate which is in turn determined by the channel delay spread. A guard interval (GI) is specified so as to account for the typical delay spreads associated with the transmission channel.

The channel bonding scheme provided by a preferred embodiment of the present invention is based on fixed FFT period and variable FFT size and provides maximum flexibility of CPE design. A lower sampling rate design (using only 1 band) can be used in order to reduce CPE cost, or a higher sampling rate design can be used in order to provide configuration flexibility during operation.

The sub-carrier allocation scheme is also defined such that it is scalable with the number of TV bands available. If only one band is available then only those sub-carriers which are within the span of the one band are allocated. In a preferred embodiment, a similar procedure is applied for the case of two and three bands. This allocation scheme enables a BS 700 to increase the number of sub-channels when additional bands are available and at the same time each of these sub-channels are spread across all the bands thus enabling frequency diversity. A CPE 600 is allocated a sub-channel or a plurality of sub-channels by its BS 700 based on its communication requirements.

FIG. 1A illustrates an example of a preferred sub-carrier allocation scheme in which sub-channels 1 through 4 are spread across all the bands to achieve frequency diversity.

FIG. 1B illustrates numbering of sub-channels for a single channel as well as a set of 2 adjacent bonded channels and a set of 3 adjacent bonded channels.

FIG. 1C illustrates an overall bandwidth allocation strategy in which 3 empty channels have been bonded by a BS 700 and assigned to MAC/PHY stack #1 and 2 empty channels have been bonded by the BS 700 and assigned to MAC/PHY stack #2.

Sub-carriers are allocated to each sub-channel in accordance with a 2 part scheme described below in the section entitled “OFDMA sub-carrier allocation.”

In the following discussions it is assumed that the PHY includes a superframe 900, superframe preamble, superframe control header (SCH) and a plurality of frames, as illustrated in FIG. 9. It is also assumed that the frame 1000, frame preamble 1004.1 and frame control header (FCH) 1004.2 are as illustrated in FIG. 10. Each said frame 1000 includes a downstream subframe DS 1002 and upstream subframe US 1003 separated by sliding coexistence slots, as illustrated in FIG. 10.

As shown in the superframe structure 900 of FIG. 9, the superframe transmission by a BS 700 begins with the transmission of a superframe preamble 400, followed by a superframe control header (SCH). Since the superframe preamble and the SCH have to be received and decoded by all CPEs 600, the constituent fields include/transmit the same information in all the available bands. The SCH includes information on the structure of the rest of the superframe 900. During each PHY superframe 900 the BS 700 manages all upstream and downstream transmission with respect to CPEs 600 in its cell 801.

In order to provide implementation simplicity (especially for the filters), both the superframe preamble and the SCH of a preferred embodiment includes an additional guard band at the band edges in each of these bands.

A top down PHY frame structure 1000 is as illustrated in FIG. 10 wherein the PHY frame 1000 includes a predominantly downstream (DS) sub-frame 1002 and an upstream (US) sub-frame 1002. In a preferred embodiment, the boundary between these two sub-frames is adaptive to facilitate control of downstream and upstream capacity and comprises sliding coexistence slots.

A DS sub-frame 1002 includes a DS PHY PDU 1004 with possible contention slots for coexistence purposes. In a preferred embodiment, there is a single DS sub-frame 1002. A downstream PHY PDU 1004 begins with a preamble 1004.1 which is used for PHY synchronization. The preamble 1004.1 is followed by an FCH burst 1004.2 which specifies the burst profile and length of one or several downstream bursts immediately following the FCH 1004.2.

A US sub-frame 1003 includes fields for contention slots scheduled for initialization, bandwidth request, urgent coexistence situation notification, and at least one US PHY PDU, each of the latter transmitted from a different CPE 600. Preceding upstream CPE PHY bursts, the BS 700 may schedule up to three contention windows:
Initialization window—used for ranging;
BW window—for CPEs 700 to request US bandwidth allocation from the BS 600; and
UCS notification window—for CPEs 700 to report and urgent coexistence situation with incumbents.

OFDMA Symbol Description

The RF signal sent by a transmitter 602 702 can be represented mathematically as

$${s}_{RF} ( t ) = Re \{ {\sum }_{n = 0}^{N - 1} {s}_{n} ( t - {nT}_{SYM} ) exp ( j 2 π {f}_{c} t ) \} , \qquad Equation 1$$

where Re(.) represents the real part of the signal, N is the number of symbols in the PPDU, T_{SYM} is the OFDM symbol duration, f_{c} is the carrier centre frequency and sₙ(t) is the complex base-band representation of the n^{th} symbol.

sₙ(t)=0 0>t≧2_{SYM}

The exact form of sₙ(t) is determined by n and whether the symbol is part of the DS or US.

Time Domain Description

The time-domain signal is generated by taking the inverse Fourier transform of the length N_{FFT} vector. The vector is formed by taking the constellation mapper output and inserting pilot and guard tones. At the receiver 601 701, the time domain signal is transformed to the frequency domain representation by using a Fourier transform. A Fast Fourier Transform (FFT) algorithm is preferably used to implement the Fourier transform and its inverse.

Let T_{FFT} represent the time duration of the IFFT output signal. The OFDMA symbol is formed by inserting a guard interval of time duration T_{GI}, as illustrated in FIG. 2, resulting in a symbol duration of T_{SYM}=T_{FFT}+T_{GI}.

The specific values for T_{FFT}, T_{GI} and T_{SYM} are given in below in the section disclosing symbol parameters. The BS determines these parameters and then conveys the information to the CPEs.

Frequency Domain Description

In the frequency domain, an OFDMA symbol is defined in terms of its sub-carriers. The sub-carriers are classified as: 1) data sub-carriers, 2) pilot sub-carriers, 3) guard sub-carriers and 4) Null (includes DC) sub-carriers. The classification is based on the functionality of the sub-carriers. The DS and US may have different allocations of sub-carriers. The total number of sub-carriers is determined by the FFT/IFFT size. FIG. 3 illustrates the frequency domain description of an OFDMA symbol (assuming 6 MHz TV bands). Except for the DC sub-carrier, all the remaining guard/Null sub-carriers are placed at the band-edges. The guard sub-carriers do not carry any energy. The pilot sub-carriers are distributed across the bandwidth. The exact location of the pilot and data sub-carriers and their sub-channel allocations is determined by the particular configuration used. The 6 MHz and 12 MHz version of the symbol is generated by nulling out sub-carriers outside the corresponding bandwidths.

The frequency domain description of an OFDMA signal is illustrated in FIG. 3. Note that this is a representative diagram. The number of sub-carriers and the relative positions of the sub-carriers do not correspond with the symbol parameters provided in Table 2.

Symbol Parameters

The inter-carrier spacing AF is fixed for the different bandwidth options of 6 MHz, 12 MHz and 18 MHz. This implies that the parameter T_{FFT} is also fixed. The guard interval duration T_{GI} is preferably one of the following derived values: T_{FFT}/32, T_{FFT}/16, T_{FFT}/8 and T_{FFT}/4.

The inter-carrier spacing ΔF=3376 Hz

$${T}_{FFT} = \frac{1}{Δ F} = 296.209 μs$$

For the case of 7 MHz and 8 MHz TV bands, the inter-carrier spacing is appropriately modified to result in the same number of sub-carriers as the 6 MHz TV band case.

The OFDM symbol duration for different values of guard interval is given in Table 1.

TABLE 1
Symbol duration for different guard intervals

| | GI = T_{FFT}/32 | GI = T_{FFT}/16 | GI = T_{FFT}/8 | GI = T_{FFT}/4 |
|---|---|---|---|---|
| T_{SYM} = | 305.650 μs | 314.722 μs | 333.235 μs | 370.261 μs |
| T_{FFT} + T_{GI} | | | | |

Table 2 shows the different parameters and their values for the three bandwidths.

TABLE 2
OFDMA parameters for the 3 bandwidths

| | Band- | Band- | Band- |
|---|---|---|---|
| | width = 18 | width = 12 | width = 6 |
| Parameter | MHz | MHz | MHz |
| Inter-carrier | 3376 | 3376 | 3376 |
| spacing, ΔF (Hz) | | | |
| FFT period, T_{FFT} (μs) | 296.209 | 296.209 | 296.209 |
| Total number of | 6144 | 4096 | 2048 |
| sub-carriers, N_{FFT} | | | |
| Number of guard | 960 (480, | 640 (320, | 320 (160, |
| sub-carriers, N_{G} (L, | 1, 479) | 1, 319) | 1, 159) |
| DC, R) | | | |
| Number of used | 5184 | 3456 | 1728 |
| sub-carriers, N_{T} = | | | |
| N_{D} + N_{P} | | | |
| Number of data | 4608 | 3072 | 1536 |
| sub-carriers, N_{D} | | | |
| Number of pilot | 576 | 384 | 192 |
| sub-carriers, N_{P} | | | |
| Signal bandwidth | 17.501184 | 11.667456 | 5.833728 |
| (MHz) | | | |

### OFDMA Sub-Carrier Allocation

Based on the parameters defined in Table 2, there are 32 sub-channels each with 54 sub-carriers in the 6 MHz mode. For the 12 MHz and 18 MHz, the number of sub-channels is 64 and 96 respectively. Each of the sub-channels has 48 data sub-carriers and 6 pilot sub-carriers.

Sub-Carrier Allocation in Downstream (DS)

In the downstream, the sub-carrier allocation is done in two steps.

In the first step, each sub-channel is allocated 54 sub-carriers with the following criteria and is given by Equation 2:

1) The sub-carriers are distributed across the bandwidth, and

2) The sub-carrier indices represent the mirror images

$$SubCarrier ( n , k ) = {N}_{ch} \times ( k - 28 ) + ( n - 1 ) \\ n = 1 , 2 , … , {N}_{ch} \\ k = 1 , 2 , … , 27 \\ SubCarrier ( n , k ) = {N}_{ch} \times ( k - 27 ) + ( n - 1 ) \\ n = 1 , 2 , … , {N}_{ch} , \\ k = 28 , 29 , … , 54 , \qquad Equation 2$$

where n and k represent the sub-channel index and sub-carrier index respectively, and N_{ch} represents the number of sub-channels and is equal to 32, 64 and 96 for single TV band, 2 TV bands and 3 TV bands respectively.

In the second step, 6 pilot sub-carriers are identified within each sub-channel. The pilot sub-carriers are distributed uniformly across the OFDMA symbol. Every 9^{th} sub-carrier in the symbol is designated as the pilot sub-carrier. Table 3 provides the pilot sub-carrier index for the 32 sub-channels. Table 3 also provides the corresponding sub-carrier numbers within the sub-channel that are defined as pilots.

The above defined sub-carrier allocation is used for all the fields in the DS except for the SCH.

Sub-Carrier Allocation in Upstream (US)

The 2-step sub-carrier allocation is also used for the US 1003. In the first step, Equation 2 is used to allocate 54 sub-carriers in each of the 32 sub-channels. In the second step, 6 pilot sub-carriers are identified within each sub-channel.

The following equation defines the location of pilot sub-carriers within the given sub-channel's 54 sub-carriers:

PilotSubCarrierInd(n,m)=5+(m−1)×9, Equation 3

where mε[1, 2, . . . , 6] is the pilot number in sub-channel n.

Optionally, the pilot sub-carriers in Upstream transmission can be transmitted at a higher power (about 3 dB) compared to the data sub-carriers.

The remaining indices are designated as data sub-carriers.

TABLE 3
Pilot allocation in each of the sub-channels for DS

| | Sub- | |
|---|---|---|
| | carrier # | |
| | within | Sub- |
| Sub- | the sub- | carrier |
| Chnl # | channel | index |
| 1 | 1 | −864 |
| 1 | 10 | −576 |
| 1 | 19 | −288 |
| 1 | 36 | 288 |
| 1 | 45 | 576 |
| 1 | 54 | 864 |
| 2 | 8 | −639 |
| 2 | 17 | −351 |
| 2 | 26 | −63 |
| 2 | 29 | 63 |
| 2 | 38 | 351 |
| 2 | 47 | 639 |
| 3 | 6 | −702 |
| 3 | 15 | −414 |
| 3 | 24 | −126 |
| 3 | 31 | 126 |
| 3 | 40 | 414 |
| 3 | 49 | 702 |
| 4 | 4 | −765 |
| 4 | 13 | −477 |
| 4 | 22 | −189 |
| 4 | 33 | 189 |
| 4 | 42 | 477 |
| 4 | 51 | 765 |
| 5 | 2 | −828 |
| 5 | 11 | −540 |
| 5 | 20 | −252 |
| 5 | 35 | 252 |
| 5 | 44 | 540 |
| 5 | 53 | 828 |
| 6 | 9 | −603 |
| 6 | 18 | −315 |
| 6 | 27 | −27 |
| 6 | 28 | 27 |
| 6 | 37 | 315 |
| 6 | 46 | 603 |
| 7 | 7 | −666 |
| 7 | 16 | −378 |
| 7 | 25 | −90 |
| 7 | 30 | 90 |
| 7 | 39 | 378 |
| 7 | 48 | 666 |
| 8 | 5 | −729 |
| 8 | 14 | −441 |
| 8 | 23 | −153 |
| 8 | 32 | 153 |
| 8 | 41 | 441 |
| 8 | 50 | 729 |
| 9 | 3 | −792 |
| 9 | 12 | −504 |
| 9 | 21 | −216 |
| 9 | 34 | 216 |
| 9 | 43 | 504 |
| 9 | 52 | 792 |
| 10 | 1 | −855 |
| 10 | 10 | −567 |
| 10 | 19 | −279 |
| 10 | 36 | 279 |
| 10 | 45 | 567 |
| 10 | 54 | 855 |
| 11 | 8 | −630 |
| 11 | 17 | −342 |
| 11 | 26 | −54 |
| 11 | 29 | 54 |
| 11 | 38 | 342 |
| 11 | 47 | 630 |
| 12 | 6 | −693 |
| 12 | 15 | −405 |
| 12 | 24 | −117 |
| 12 | 31 | 117 |
| 12 | 40 | 405 |
| 12 | 49 | 693 |
| 13 | 4 | −756 |
| 13 | 13 | −468 |
| 13 | 22 | −180 |
| 13 | 33 | 180 |
| 13 | 42 | 468 |
| 13 | 51 | 756 |
| 14 | 2 | −819 |
| 14 | 11 | −531 |
| 14 | 20 | −243 |
| 14 | 35 | 243 |
| 14 | 44 | 531 |
| 14 | 53 | 819 |
| 15 | 9 | −594 |
| 15 | 18 | −306 |
| 15 | 27 | −18 |
| 15 | 28 | 18 |
| 15 | 37 | 306 |
| 15 | 46 | 594 |
| 16 | 7 | −657 |
| 16 | 16 | −369 |
| 16 | 25 | −81 |
| 16 | 30 | 81 |
| 16 | 39 | 369 |
| 16 | 48 | 657 |
| 17 | 5 | −720 |
| 17 | 14 | −432 |
| 17 | 23 | −144 |
| 17 | 32 | 144 |
| 17 | 41 | 432 |
| 17 | 50 | 720 |
| 18 | 3 | −783 |
| 18 | 12 | −495 |
| 18 | 21 | −207 |
| 18 | 34 | 207 |
| 18 | 43 | 495 |
| 18 | 52 | 783 |
| 19 | 1 | −846 |
| 19 | 10 | −558 |
| 19 | 19 | −270 |
| 19 | 36 | 270 |
| 19 | 45 | 558 |
| 19 | 54 | 846 |
| 20 | 8 | −621 |
| 20 | 17 | −333 |
| 20 | 26 | −45 |
| 20 | 29 | 45 |
| 20 | 38 | 333 |
| 20 | 47 | 621 |
| 21 | 6 | −684 |
| 21 | 15 | −396 |
| 21 | 24 | −108 |
| 21 | 31 | 108 |
| 21 | 40 | 396 |
| 21 | 49 | 684 |
| 22 | 4 | −747 |
| 22 | 13 | −459 |
| 22 | 22 | −171 |
| 22 | 33 | 171 |
| 22 | 42 | 459 |
| 22 | 51 | 747 |
| 23 | 2 | −810 |
| 23 | 11 | −522 |
| 23 | 20 | −234 |
| 23 | 35 | 234 |
| 23 | 44 | 522 |
| 23 | 53 | 810 |
| 24 | 9 | −585 |
| 24 | 18 | −297 |
| 24 | 27 | −9 |
| 24 | 28 | 9 |
| 24 | 37 | 297 |
| 24 | 46 | 585 |
| 25 | 7 | −648 |
| 25 | 16 | −360 |
| 25 | 25 | −72 |
| 25 | 30 | 72 |
| 25 | 39 | 360 |
| 25 | 48 | 648 |
| 26 | 5 | −711 |
| 26 | 14 | −423 |
| 26 | 23 | −135 |
| 26 | 32 | 135 |
| 26 | 41 | 423 |
| 26 | 50 | 711 |
| 27 | 3 | −774 |
| 27 | 12 | −486 |
| 27 | 21 | −198 |
| 27 | 34 | 198 |
| 27 | 43 | 486 |
| 27 | 52 | 774 |
| 28 | 1 | −837 |
| 28 | 10 | −549 |
| 28 | 19 | −261 |
| 28 | 36 | 261 |
| 28 | 45 | 549 |
| 28 | 54 | 837 |
| 29 | 8 | −612 |
| 29 | 17 | −324 |
| 29 | 26 | −36 |
| 29 | 29 | 36 |
| 29 | 38 | 324 |
| 29 | 47 | 612 |
| 30 | 6 | −675 |
| 30 | 15 | −387 |
| 30 | 24 | −99 |
| 30 | 31 | 99 |
| 30 | 40 | 387 |
| 30 | 49 | 675 |
| 31 | 4 | −738 |
| 31 | 13 | −450 |
| 31 | 22 | −162 |
| 31 | 33 | 162 |
| 31 | 42 | 450 |
| 31 | 51 | 738 |
| 32 | 2 | −801 |
| 32 | 11 | −513 |
| 32 | 20 | −225 |
| 32 | 35 | 225 |
| 32 | 44 | 513 |
| 32 | 53 | 801 |

### Channel Coding

Channel coding includes data scrambling 401, RS coding (optional) 402.1, convolutional coding 402.2, puncturing 402.3, bit interleaving 403 and constellation mapping 404. FIG. 4 illustrates the mandatory channel coding process. The channel coder processes the control headers and the PSDU portion of the PPDU 1004, see FIG. 10. The channel coder does not process the preamble part 1004.1 of the PPDU.

For the purpose of channel coding, each data burst 500.i is further sub-divided into data blocks 500.i.j as illustrated in FIG. 5. Each block of encoded data is mapped and transmitted on a sub-channel. In a preferred embodiment, distributed sub-carrier allocation is used to define sub-channels. In an alternative embodiment where contiguous sub-carrier allocation is used, multiple blocks of encoded data are mapped and transmitted on multiple sub-channels.

### Constellation Mapping and Modulation

Spread OFDMA Modulation

Data Modulation

Referring now to FIG. 4, the output of the bit interleaver 403 is entered serially to the constellation mapper 404. The input data to the mapper 404 is first divided into groups of N_{CBPC} (2, 4 or 6) bits and then converted into complex numbers representing QPSK, 16-QAM or 64-QAM constellation points. The mapping is done according to Gray-coded constellation mapping. The complex valued number is scaled by a modulation dependent normalization factor K_{MOD}. Table 4 provides the K_{MOD} values for the different modulation types defined in this section. The number of coded bits per block (N_{CBPB}) and the number of data bits per block for the different constellation type and coding rate combinations are summarized in Table 5. Note that a block corresponds to the data transmitted in a single sub-channel.

TABLE 4
Modulation dependent normalization factor

| Modulation Type | N_{CBPC} | K_{MOD} |
|---|---|---|
| QPSK | 2 | 1/\sqrt{2} |
| 16-QAM | 4 | 1/\sqrt{10} |
| 64-QAM | 6 | 1/\sqrt{42} |

TABLE 5
The number of coded bits per block (N_{CBPB}) and the
number of data bits per block (N_{DBPB}) for the different
constellation type and coding rate combinations

| Constellation | | | |
|---|---|---|---|
| type | Coding rate | N_{CBPB} | N_{DBPB} |
| QPSK | ½ | 96 | 48 |
| QPSK | ¾ | 96 | 72 |
| 16-QAM | ½ | 192 | 96 |
| 16-QAM | ¾ | 192 | 144 |
| 64-QAM | ½ | 288 | 144 |
| 64-QAM | ⅔ | 288 | 192 |
| 64-QAM | ¾ | 288 | 216 |
| 64-QAM | ⅚ | 288 | 240 |

Spread OFDMA

A 16×16 matrix is used to spread the output of the constellation mapper 404. The type of the matrix used for different configurations is determined by a PHY mode parameter. For purpose of spreading, the output of the constellation mapper 404 is grouped into a symbol block of 16 symbols. Since each data block preferably results in 48 symbols, a data block generates 3 such symbol blocks.

The spreading is performed according to the following equation

S=CX

where X represents the constellation mapper output vector and is given as X=[x₁, x₂, . . . , x₁₆]^{T},

S represents the spread symbols which are defined as S=[s₁, s₂, . . . , s₁₆]^{T} and C represents a spreading matrix. For example, in the case of Hadamard spreading, C=H₁₆ represents a hadamard spreading matrix and is given by the following Equation

$${H}_{{2}^{n}} = [ \begin{matrix}{H}_{{2}^{n - 1}} & {H}_{{2}^{n - 1}} \\ {H}_{{2}^{n - 1}} & - {H}_{{2}^{n - 1}}\end{matrix} ]$$

where H₁=[1] and

$${H}_{2} = [ \begin{matrix}1 & 1 \\ 1 & - 1\end{matrix} ] .$$

The spreading matrix is C=I_{16×16}, an identity matrix, when non-spreading mode is selected.

Pilot Modulation

The pilots are mapped using QPSK constellation mapping. Spreading is not used on the pilots.

The pilots are defined as

$${S}_{p} ( k ) = \begin{matrix}{P}_{REF} ( k ) & k < 0 , and k ∈ pilot\_indices \\ 0 & otherwise\end{matrix}$$

$$and$$

$${S}_{p} ( k ) = \begin{matrix}conj ( {P}_{REF} ( - k ) ) & k > 0 , and k ∈ pilot\_indices \\ 0 & otherwise\end{matrix}$$

P_{REF} is defined below.

P_{REF} is preferably generated by using two length-8191 pseudo random sequence generators and by forming QPSK symbols by mapping the first 5184 bits of these sequence to the I and Q components respectively. The generator polynomials of a preferred pseudo random sequence generator are given as

### X¹³+X¹¹+X¹⁰+X⁹+X⁵+X³+1 and

### X¹³+X¹¹+X¹⁰+1

The pseudo random generators are initialized with a value of 0 1000 0000 0000. The first 32 output bits generated by the first generator (and mapped on to I-component) are 0000 0000 0001 0110 0011 1001 1101 0100 and the corresponding reference preamble symbols are given as

P_{REF}(−2592:2561)={−1−j, −1−j, −1−j, −1−j, −1−j, −1+j, −1−j, −1−j, −1+j, −1−j, −1−j, +1+j, −1−j, +1+j, +1−j, −1−j, −1+j, −1−j, +1+j, +1+j, +1+j, −1+j, −1−j, +1−j, +1−j, +1−j, −1−j, +1+j, −1+j, +1−j, −1+j, −1+j}.

Referring now to FIG. 7, a preferred embodiment of a BS 700 is illustrated in which the BS 700 requests measurements of occupied spectrum by including the request in a superframe 900 transmitted by a transmitter module 702 to all CPEs 600 within RF range of the BS 700. The BS 700 receives the responses from the CPEs 600 which are processed by a receiver module 701 and stored in an occupied TV spectrum memory 704. The BS determines TV channel bonding of up to 3 vacant and adjacent TV channels based on these stored measurements, stores the bonding results in a TV channel bonding memory 705, and sends instructions for TV channel usage to the CPEs within RF range based on the determined TV channel bonding. The request for measurements, determination of TV channel bonding, and instructions for TV channel bonding are performed by the BS 700 on a regular periodic basis and reinstruction concerning TV channel bonding of all CPEs within RF range of the BS 700 is possible on the same regular periodic basis in order to avoid interference with incumbents.

Referring now to FIG. 6, in a preferred embodiment of a CPE 600, a receiver 601 comprises a processing module 601.1 that combines corresponding symbols from sub-channels and decodes the FCH 1004.2 data to determine the lengths of the following fields in the frames 500.i. The CPE 600 also receives from a BS 700 requests for measurements of occupied TV spectrum which are processed by a spectrum sensor processing module 603, responses being formatted by transmitter processing module 602.1 and transmitted in a superframe 900 by a transmitter 602. The CPE 600 receives via receiver 601 instructions from the BS 700 in superframes 900 concerning which TV channels to use and stores these instructions in a TV channel bonding memory 604. Thereafter, the CPE 600 uses the bonded TV channels for transmission and reception until instructed otherwise by the BS 700.

FIG. 8 illustrates a WRAN 800 deployment configuration modified according to the present invention, i.e., a plurality of overlapping WRAN cells 801 each of which includes a WRAN BS 700 modified/defined according to the present invention and at least one WRAN CPE 600 modified/defined according to the present invention.

While the preferred embodiments of the present invention have been illustrated and described, it will be understood by those skilled in the art that the embodiment of the present invention as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the claims appended hereto as well as all implementation techniques.

I claim:

1. A WRAN communication system (800) based on a superframe (900), comprising:
at least one WRAN cell (801) including:
a base station (BS) (700) to manage the WRAN cell (801), and
at least one consumer premise equipment (CPE) (600) managed by the BS (700); and
a PHY layer based on said superframe (900) including a channel bonding by said base station (700) to dynamically bond up to three adjacent empty TV channels such that an FFT period is kept constant while a corresponding FFT size varies with the number of channels bonded,
wherein, said BS (700) dynamically adjusts said channel bonding and reallocates said sub-carriers based on instantaneous channel occupancy by incumbents thereof and communicates said adjustment and reallocation to said at least one CPE (600) in said superframe (900) simultaneously transmitted across all bands of said dynamically bonded TV channels.

2. The system (800) of claim 1, wherein the PHY layer further comprises a scalable and dynamic sub-carrier allocation including:
a sub-channel definition for said bonded channels; and
a pilot and data carrier allocation within a sub-channel,
wherein, the sub-carrier allocation is distributed across all bands of said bonded channels to achieve frequency diversity.

3. The system (800) of claim 2, wherein the PHY layer further comprises a data burst definition having each data burst (500.i) sub-divided into data blocks (500.i.j) and each block of encoded data mapped and transmitted in a single sub-channel.

4. The system (800) of claim 3, wherein the PHY layer further comprises a spread OFDMA modulation such that a symbol block comprises 16 symbols and is spread by a 16×16 matrix, and a data block comprises 3 said symbol blocks.

5. The system (800) of claim 4, wherein the at least one CPE (600) is allocated at least one sub-channel by the BS (700) based on the communication requirements of the at least one CPE (600).

6. The system (800) of claim 5, wherein a pilot is mapped using QPSK constellation mapping and spreading is not used on a pilot.

7. The system (800) of claim 6, wherein the spreading matrix is a Hadamard spreading matrix.

8. The system (800) of claim 7, wherein for a first mode each channel has 32-sub-channels, and for a second mode and a third mode, the number of sub-channels is 64 and 96 respectively each sub-channel having 48 data sub-carriers and 6 pilot sub-carriers.

9. A method for providing a PHY layer in a WRAN communication system (800) based on a superframe (900), comprising the steps of:
providing at least one WRAN cell (801) including a base station (BS) (700) to manage the WRAN cell (801) and at least one consumer premise equipment (CPE) (600) managed by the BS (700); and
providing a PHY layer based on said superframe (900) by said BS (700) performing the steps of:
is allocated at least one sub-channel by the BS (700) based on the communication requirements of the CPE (600) dynamically bonding a number of up to three adjacent empty TV channels such that an FFT period is kept constant while a corresponding FFT size varies with the number of channels bonded;
allocating sub-carriers of each said bonded channels in a scalable and dynamic manner such that the allocated sub-carriers are distributed across all bands of said bonded channels to achieve frequency diversity, by performing the steps of—
defining sub-channels across said bonded channels,
allocating pilot and data carriers within said defined sub-channels,
dynamically adjusting said number of bonded channels and reallocating said sub-carriers based on instantaneous channel occupancy by incumbents thereof; and
communicating said adjusted number of bonded channels and reallocated sub-carriers to said at least one CPE (600) in said superframe (900) simultaneously transmitted across all bands of said dynamically adjusted and bonded TV channels.

10. The method of claim 9, wherein the provided PHY layer further comprises a scalable and dynamic sub-carrier allocation including:
a sub-channel definition for said bonded channels; and
a pilot and data carrier allocation within a sub-channel,
wherein, the sub-carrier allocation is distributed across all bands of said bonded channels to achieve frequency diversity.

11. The method of claim 10, wherein the provided PHY layer further comprises a data burst definition where each data burst (500.i) is sub-divided into data blocks (500.i.j) and each block of encoded data is mapped and transmitted on a single sub-channel.

12. The method of claim 11, wherein the provided PHY layer further comprises a spread OFDMA modulation such that a symbol block comprises 16 symbols and is spread by a 16×16 matrix, and a data block comprises 3 said symbol blocks,

13. The method of claim 12, further comprising the step of BS (700) allocating the at least one CPE (600) at least one sub-channel based on the communication requirements of the at least one CPE (600).

14. The method of claim 13, further comprising the step of mapping a pilot using QPSK constellation mapping such that spreading is not used on a pilot.

15. The method of claim 14, wherein the spreading matrix is a Hadamard spreading matrix.

16. The method of claim 15, wherein for a first mode each channel has 32-sub-channels, and for a second mode and a third mode, the number of sub-channels is 64 and 96 respectively each sub-channel having 48 data sub-carriers and 6 pilot sub-carriers.

17. A consumer premise equipment (CPE) (600) managed by a base station (BS) (700) for a WRAN communication system (800) based on a superframe (900), comprising:
a PHY layer based on said superframe (900) including a dynamic channel bonding mechanism, a scalable and dynamic sub-carrier allocation scheme, a data burst definition, and a spread OFDMA modulation;
a receiver (601) comprising a processing module (601.1) to receive from said base station (700) and store in a bonding memory 604 said superframe (900) simultaneously transmitted across all bands of said dynamically bonded TV channels—
a dynamic channel bonding of up to three adjacent empty TV channels such that an FFT period is kept constant while a corresponding FFT size varies with the number of channels bonded, and
a scalable and dynamic sub-carrier allocation including—
a. a sub-channel definition for said bonded channels, and
b. a pilot and data carrier allocation within a sub-channel, such that the sub-carrier allocation is distributed across all bands of said dynamic channel bonding to achieve frequency diversity;
a transmitter (602) comprising a processing module (602.1) using the PHY layer having a data burst (500.i) sub-divided into data blocks (500.i.j) such that each block of encoded data is mapped and transmitted thereby in a single sub-channel,
wherein, the spread OFDMA modulation employed by said transmitter (601) and said receiver (602) uses a symbol block definition comprising 16 symbols that is spread by a 16×16 matrix, and a data block comprises 3 said symbol blocks.

18. The CPE (600) of claim 17, wherein the CPE (600) is allocated at least one sub-channel by the BS (700) based on the communication requirements of the CPE (600).

19. The CPE (600) of claim 18, wherein a pilot is mapped using QPSK constellation mapping and spreading is not used on a pilot.

20. The CPE (600) of claim 19, wherein the spreading matrix is a Hadamard spreading matrix.

21. The CPE (600) of claim 20, wherein for a first mode each channel has 32-sub-channels, and for a second mode and a third mode, the number of sub-channels is 64 and 96 respectively each sub-channel having 48 data sub-carriers and 6 pilot sub-carriers.

22. A base station (BS) (700) to manage as WRAN cell (801) including at least one consumer premise equipment (CPE) (600) for a WRAN communication system (800) based on a superframe (900), comprising:
a PHY layer based on said superframe (900) including a dynamic channel bonding mechanism, a scalable and dynamic sub-carrier allocation scheme, a data burst definition, and a spread OFDMA modulation;
a transmitter module (702) to format and transmit said superframe (900) simultaneously across all bands of said dynamically bonded TV channels said superframe (900) including
a dynamic channel bonding of up to three adjacent empty TV channels such that an FFT period is kept constant while a corresponding FFT size varies with the number of channels bonded, and
a scalable and dynamic sub-carrier allocation including—
a. a sub-channel definition for said bonded channels, and
b. a pilot and data carrier allocation within a sub-channel, such that the sub-carrier allocation is distributed across all bands of said dynamic channel bonding to achieve frequency diversity,
wherein the at least one CPE (700) is allocated at least one sub-channel by the BS (700) based on a communication requirement of the at least one CPE (600); and
a receiver module (701) using the PHY layer to receive a superframe (900) that include the communication requirement of the at least one CPE (700),
wherein, the spread OFDMA modulation employed by said transmitter (601) and said receiver (602) uses a symbol block definition comprising 16 symbols that is spread by a 16×16 matrix, and a data block comprises 3 said symbol blocks.

23. The BS (700) of claim 22, wherein a pilot is mapped using QPSK constellation mapping and spreading is not used on a pilot.

24. The BS (700) of claim 23, wherein the 16×16 matrix is a Hadamard spreading matrix.

25. The BS (700) of claim 24, wherein for a first mode each channel has 32-sub-channels, and for a second mode and a third mode, the number of sub-channels is 64 and 96 respectively each sub-channel having 48 data sub-carriers and 6 pilot sub-carriers.
